(19) United States
(12) Patent Application Publication
(10) Pub. No.: US 2012/0285779 A1
(43) Pub. Date: Nov. 15, 2012

(54) Shape Memory Polymer Isolator for Downhole Electronics

(75) Inventor: Marc N. Samuelson, Houston, TX (US)

(73) Assignee: Baker Hughes Incorporated, Houston, TX (US)

(21) Appl. No.: 13/105,945

(22) Filed: May 12, 2011

(51) Int. Cl. F16F 7/00; B23P 11/00

(52) U.S. Cl. 188/378; 29/428

(57) ABSTRACT

Devices and methods for mounting and/or isolating members within housings. In described embodiments, a compressible shape memory polymer is used to provide this isolation. Particular embodiments are described wherein exemplary electronic circuit boards are disposed within carrier housings along with one or more protective spacers formed of shape memory polymer.

### BACKGROUND OF THE INVENTION

1. Field of the Invention

The invention relates generally to devices and methods for isolation of components or providing cushioning between two components. In particular aspects, the invention relates to the isolation and protection of electronic or other sensitive components to used in a downhole environment.

2. Description of the Related Art

Electronic circuit boards and electronic components for downhole tools are typically mounted on board that is then mounted to a rigid support chassis. This assembly is then mounted within a downhole tool. The chassis commonly has vibration isolators of limited protective capacity that are in the form of elastomeric o-rings to cushion the chassis.

### SUMMARY OF THE INVENTION

The present invention provides improved devices and methods for mounting and/or isolating components generally. In described embodiments, a compressible shape memory polymer, such as TEMBO® shape memory polymer, is used to provide this mounting and/or isolation. Particular embodiments are described wherein exemplary electronic circuit boards are disposed within carrier housings along with one or more protective spacers formed of shape memory polymer in order to form component assemblies. In preferred embodiments, the spacers are in a compressed form and disposed upon portions of the circuit board to be isolated. In described embodiments, one or more spacers are affixed to portions of the board by a suitable adhesive. The board and spacers are inserted into the housing. Thereafter, the spacers are caused to expand to an uncompressed form such that outer surfaces of the spacers contact the housing and provide isolation. The resulting component assembly can then be used within a downhole tool. In specific embodiments, the component assembly of board, spacers and housing are heated to a point which causes the spacers to transition from a compressed state to an uncompressed state. When the component assembly cools, the spacers become substantially rigid and will mount the circuit board within the housing. The spacers may also provide protection against vibration and impact. In addition, the spacers may provide electrical isolation between the chassis and the surrounding housing.

In accordance with described methods, the shape memory polymer is first fabricated in its uncompressed state and then formed to its desired end configuration. The polymer is then placed into its compressed state. In described embodiments, the polymer is heated and then mechanically compressed. In a further described embodiment, cylindrical fabricated portions of shape memory polymer foam are formed and then sliced to make the spacers.

One or more spacers provide a means for mounting and/or an isolator for a circuit board or other member which is disposed within a housing. The systems and methods of the present invention preferably eliminate the need for a separate support chassis.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is an external, isometric view of an exemplary electronics chassis with spacers being attached, in accordance with the present invention.

FIG. 2 is an external, isometric view of the chassis and spacers of FIG. 1, now being inserted into a carrier tube to form a component assembly.

FIG. 3 is an external, isometric view of the component assembly, prior to expansion of the spacers.

FIG. 4 is a cross-sectional view taken along lines 4-4.

FIG. 5 is an external, isometric view of the component assembly, following expansion of the spacers.

FIG. 6 is a cross-sectional view taken along lines 6-6 in FIG. 5.

FIG. 7 illustrates an alternative embodiment for disposing spacers upon a chassis.

FIG. 7A is a side view of an exemplary spacer of the type used in FIG. 7.

FIG. 8 is an external, isometric view of an exemplary fabricated portion of shape memory polymer which is being used to create a plurality of spacers.

FIG. 9 is a side, partial cross-sectional view illustrating an exemplary gage carrier which contains carrier tubes constructed in accordance with the present invention.

### DETAILED DESCRIPTION OF THE PREFERRED EMBODIMENTS

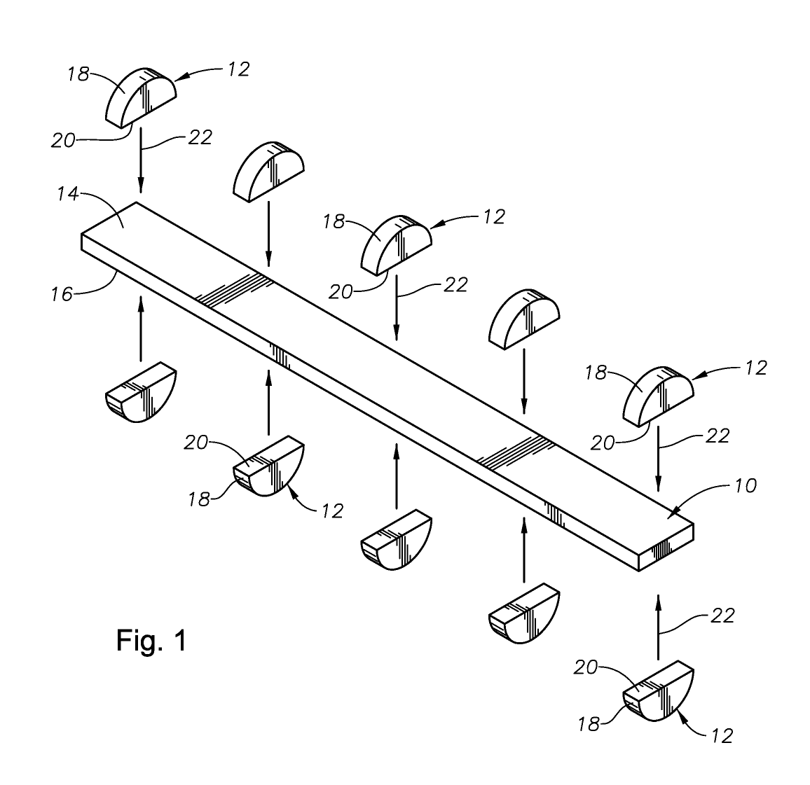

FIG. 1 depicts an exemplary electronic circuit board 10 which typically includes electronic circuitry, components and the like. The board 10 is shown to have an elongated rectangular shape. However, other suitable shapes may be used. Spacers 12 are shown being disposed upon the board 10 at various intervals along the length of the board 10. It is noted that the spacers 12 are preferably disposed upon both the upper side surface 14 and the lower side surface 16 of the board 10. Those of skill in the art will understand that, although a circuit board 10 is used in this explanation, other members which are sought to be protected might also be used.

In the depicted embodiment, the spacers 12 have a generally semi-circular cross-section with an arcuate, or semi-circular, outer radial surface 18. The particular shape of the outer surface 18 may vary, but is preferably selected to be generally complimentary to the shape of the housing into which the board 10 and spacers 12 will be disposed. Each spacer 12 also preferably presents an inner contact surface 20 that is shaped to be generally complimentary to a portion of the board 10 upon which the spacer 12 will be disposed. In the embodiment depicted in FIG. 1, the inner contact surface 20 is substantially flat since the side surfaces 14, 16 upon which the spacers 12 will be disposed are also substantially flat. The spacers 12 are disposed upon the upper and lower sides 14, 16, as indicated by the arrows 22 in FIG. 1. In preferred embodiments, a suitable glue or adhesive is used to affix the spacers 12 to the board 10. Alternatively, a mechanical connector, such as a dowel pin, of a type known in the art, may be used to secure the spacers 12 to the board 10.

Preferably, the spacers 12 are each formed of a material that is compressible from an uncompressed state to a compressed state. Preferably also, the material forming the spacers 12 has shape memory such that the spacer 12 can return to its uncompressed state from the compressed state. In embodiments, the shape memory material forming the spacers 12 transforms from the compressed state to the uncompressed state upon application of heat to the spacers 12 sufficient to raise the temperature of the spacers 12 to a point wherein the spacers 12 will transition to the uncompressed state. In further embodiments, the material forming the spacers 12 comprises foam, which permits significant compression and expansion to occur. In currently preferred embodiments, the spacers 12 are formed of syntactic foam. One suitable syntactic foam for use in forming the spacers 12 is the TEMBO® shape memory polymer which is available commercially from Composite Technology Development, Inc. of Lafayette, Colo. When the spacers 12 are disposed upon the board 10, they are in their compressed state.

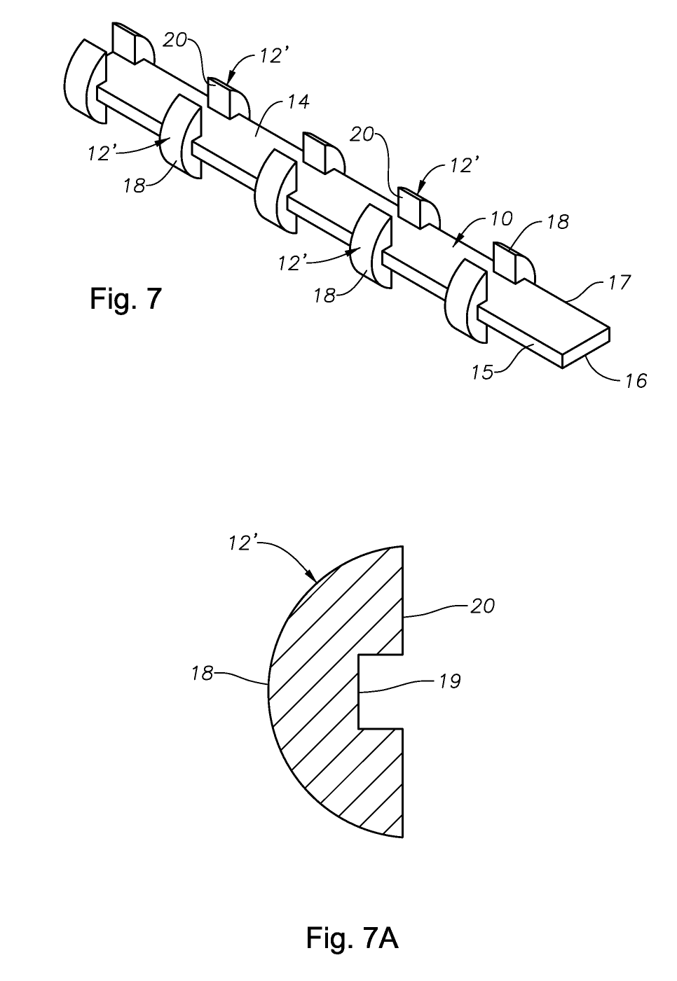

FIGS. 7 and 7A illustrate an exemplary alternative embodiment wherein spacers 12′ are disposed upon edges 15, 17, which are formed between the upper and lower side surfaces 14, 16 of the board 10. FIG. 7A depicts a single spacer 12′ apart from the other components. The spacers 12′ are similar in construction to the spacers 12. However, there is a notch 19 formed in the inner contact surface 20 of the spacer 12′. The notch 19 is shaped and sized to interfit with one of the edges 15, 17 of the board 10. In some embodiments, an adhesive is used to secure the spacers 12′ to the board 10.

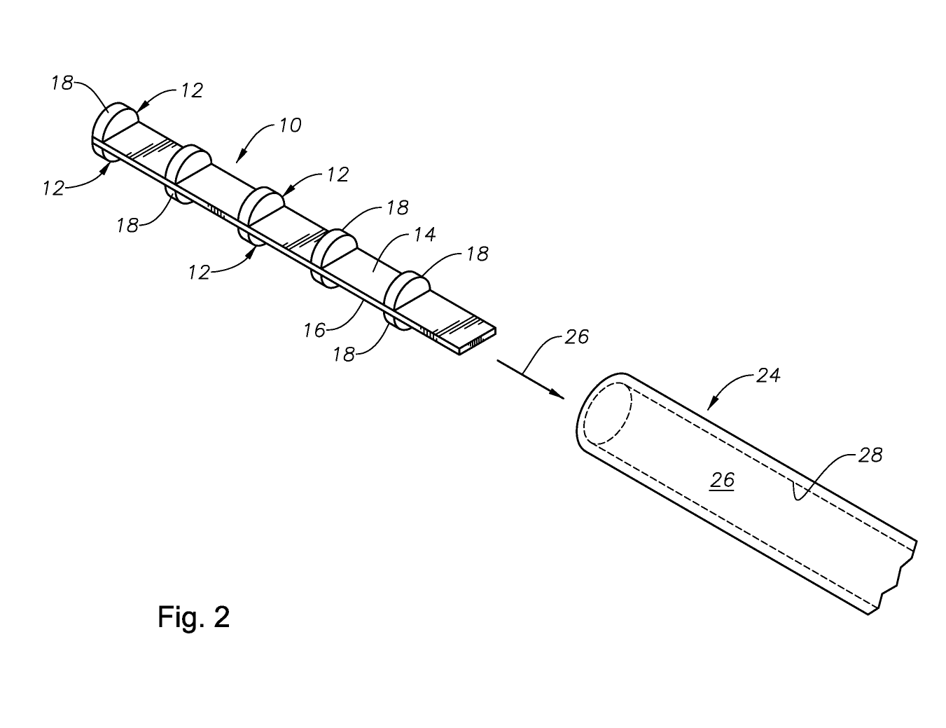

FIG. 2 illustrates the assembled board 10 and spacers 12 being inserted into an exemplary carrier tube, or housing, 24, as indicated by arrow 26. It is noted that the exemplary carrier tube 24 has a generally cylindrical shape which defines a central bore 26 having a radially inner radial surface 28. Although the carrier tube 24 is shown in this example, to have a cylindrical shape, other suitable shapes could also be used, including shapes having oval, square, rectangular or triangular cross-sections or irregular cross-sectional shapes. The carrier tube 24 is preferably formed of metal, although other suitable materials may be used.

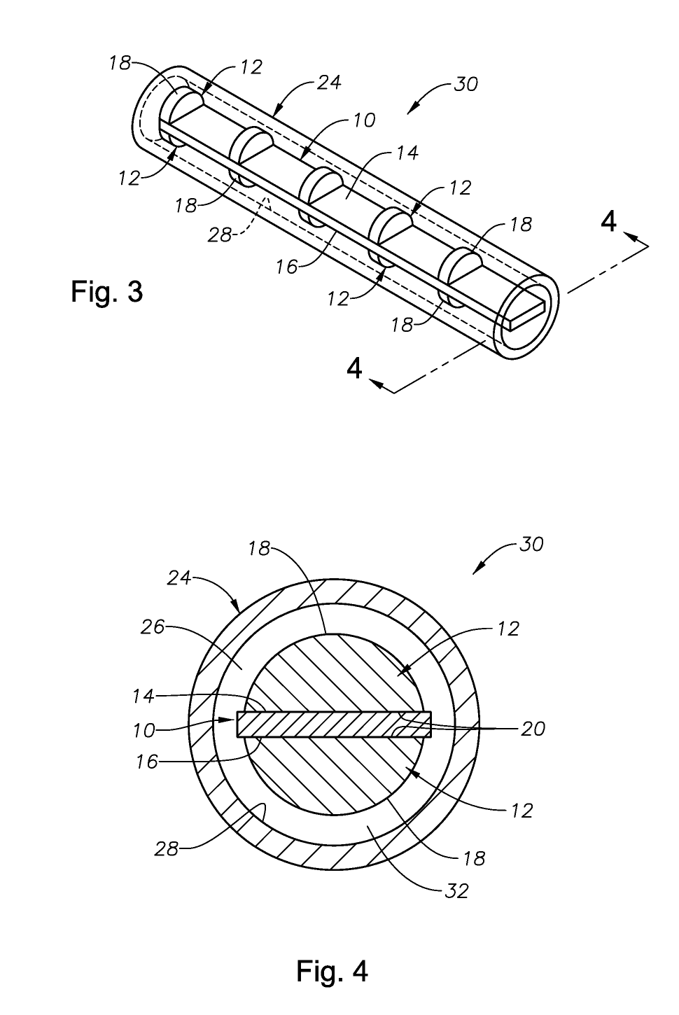

FIGS. 3 and 4 depict the assembled board 10 and spacers 12 now having been disposed within the carrier tube 24 to form a component assembly 30. It is noted that, because the spacers 12 are in their compressed state, there is a gap 32 within the bore 26 between the outer radial surface 18 of the spacers 12 and the inner radial surface 28 of the carrier tube 24. The gap 32 permits the board 10 and spacers 12 to be easily inserted into the bore 26 of the carrier tube 24.

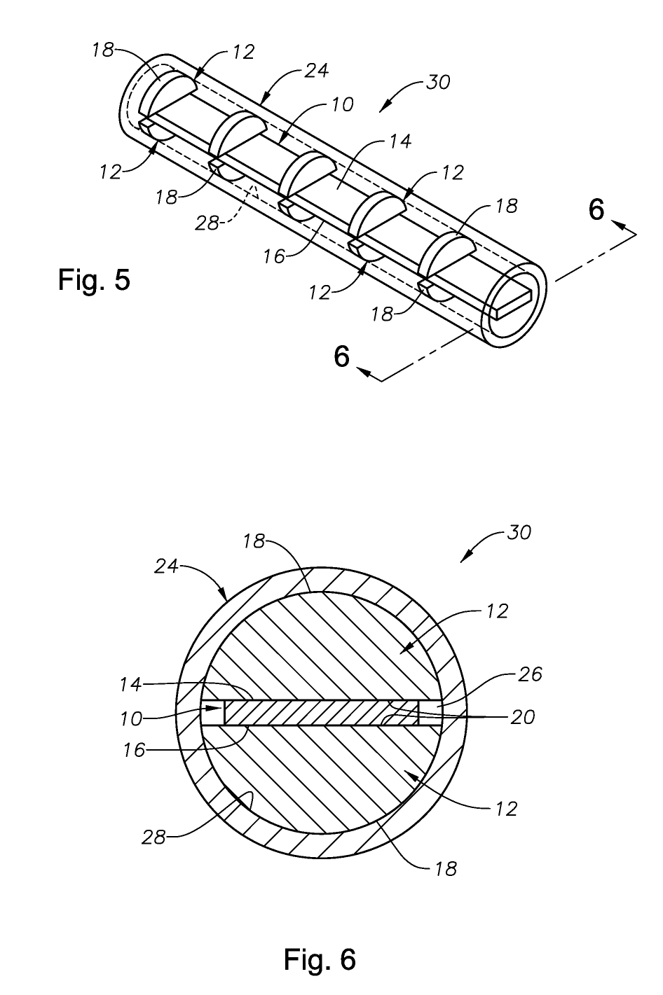

Once the board 10 and spacers 12 have been inserted into the carrier tube 24, the component assembly 30 is then heated to cause the spacers 12 to transition to their uncompressed state, as shown in FIGS. 5 and 6. As the spacers 12 expand, the gap 32 is closed as the outer radial surfaces 18 of the spacers 12 are brought into contact with the inner radial surface 28 of the carrier tube 24. Heating of the component assembly 30 may be conducted using baking techniques which are often conventionally employed to bake the circuit board 10 prior to its use downhole. During heating, it is preferred to heat the component assembly 30 at least to temperatures in the range of 160° to 180° F. Following heating, the component assembly 30 cools to approximately room temperature, and the shape memory polymer forming the spacers 12 or 12′ will become substantially rigid and lock the circuit board 10 in place within the carrier tube 24.

In addition to physically mounting the circuit board 10 within the carrier tube 24, the spacers 12, 12′ of the component assembly 30 preferably also provide isolation in the form of protection to the board 10 from vibration and shock. In addition, the spacers 12, 12′ preferably also provide a degree of protection to the circuit board 10 from intrusion of fluids and debris. FIG. 9 illustrates an exemplary gage carrier downhole tool 38 which is incorporated into work string 40. Component assemblies 30 are disposed within.

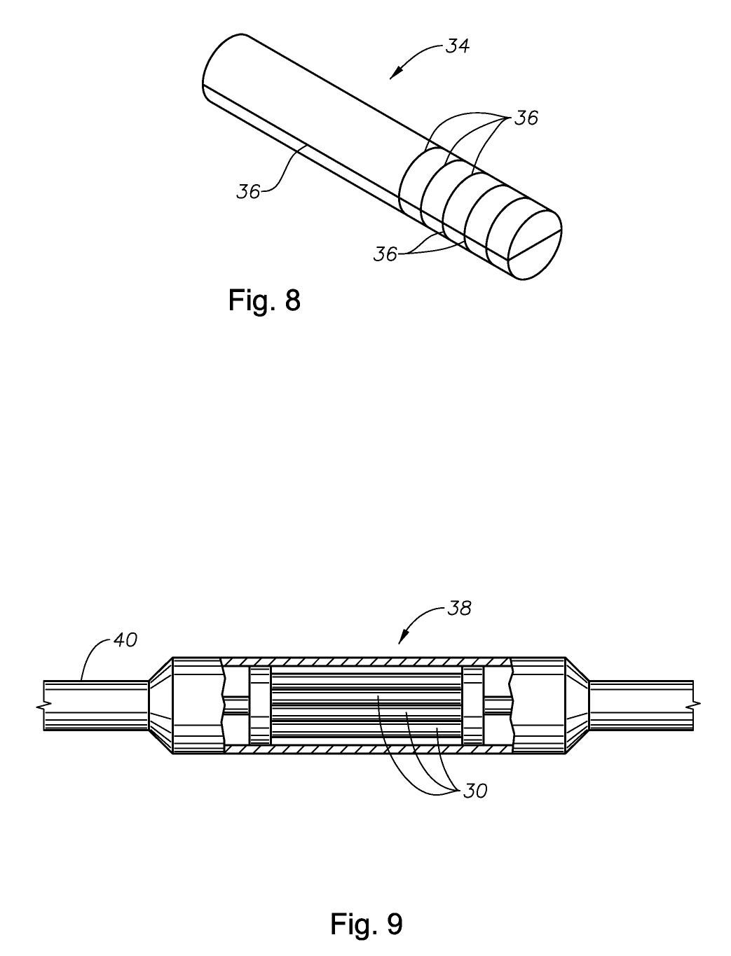

To create the spacers 12 or 12′, the shape memory polymer is first fabricated in its uncompressed state and then formed to its desired end configuration. In certain current embodiments, the polymer is heated and then compacted into its compressed state. In particular embodiments, fabricated portions of shape memory polymer are formed and then compressed using suitable mechanical processes including rolling, pressing, folding and the like. FIG. 8 depicts an exemplary cylindrical fabricated portion 34 of shape memory polymer from which cuts 36 are made to form the individual spacers 12. Spacer 12′ can be formed by cutting the notch 19 thereafter.

It should be appreciated by those of skill in the art that one or more of the spacers 12 or 12′ will serve as an isolator to protect the circuit board 10 from vibration and shock within the surrounding carrier tube 24. The spacers 12 or 12′ might also provide for electrical isolation of the circuit board 10. The shape memory polymer can be designed for specific applications. It can provide a rigid support or a softer, dampening support depending upon the specific formulation, as is known to those of skill in the art.

The devices and methods of the present invention are applicable to provide cushioning and protection to a wide variety of devices and components within a wide variety of carrier tubes or other housings. Those of skill in the art will recognize that numerous modifications and changes may be made to the exemplary designs and embodiments described herein and that the invention is limited only by the claims that follow and any equivalents thereof.

What is claimed is:

1. An isolator for use in mounting a member to be protected from vibration and shock within a housing, the isolator comprising:
a spacer formed of a shape memory polymer that is convertible between an uncompressed state and a compressed state, and being disposed upon the member in the compressed state;
the spacer presenting a first surface that is formed to reside upon a portion of the member in a generally complimentary manner; and
the spacer presenting a second surface that contacts the housing when in the uncompressed state.

2. The isolator of claim 1 wherein the shape memory polymer comprises a syntactic foam.

3. The isolator of claim 1 wherein the isolator comprises a plurality of spacers.

4. The isolator of claim 1 wherein the spacer is affixed to the member.

5. The isolator of claim 1 wherein the spacer presents:
a first contact surface that is shaped to be generally complimentary to a portion of the member upon which the spacer will be disposed; and
a second contact surface that is shaped to be generally complimentary to an interior surface of the housing.

6. A component assembly for use within a well tool, comprising:
a member to be protected from vibration and shock;
a housing within which the member is disposed;
a spacer disposed between the member and the housing, the spacer being formed of a shape memory polymer that is convertible between an uncompressed state and a compressed state; and
the spacer having been converted to its uncompressed state to contact both the member and the housing and thereby secure the member in place within the housing.

7. The component assembly of claim 6 wherein the member comprises an electronic circuit board.

8. The component assembly of claim 6 wherein there is a plurality of spacers.

9. The component assembly of claim 6 wherein the shape memory polymer comprises syntactic foam.

10. The component assembly of claim 6 wherein the housing comprises a cylindrical carrier tube.

11. The component assembly of claim 6 wherein the spacer is affixed to the member.

12. A method of isolating a member for protection from vibration and shock, the method comprising the steps of:
disposing a spacer upon the member, the spacer being formed of a shape memory polymer that is convertible between an uncompressed state and a compressed state, the spacer being in the compressed state;
disposing the member and spacer within the housing to form a component assembly; and
converting the spacer from the compressed state to the uncompressed state to cause the spacer to contact the housing.

13. The method of claim 12 wherein the spacer is converted from the compressed state to the uncompressed state by heating the component assembly.

14. The method of claim 12 further comprising the step of compressing the spacer into the compressed state prior to disposing it upon the member.

15. The method of claim 13 further comprising the step of cooling the component assembly after heating.

16. The method of claim 12 further comprising the step of affixing the spacer to the member prior to disposing the member and spacer within the housing.

17. The method of claim 12 wherein the member comprises a circuit board having upper and lower side surfaces and wherein:
the step of disposing the spacer upon the member further comprises disposing the spacer upon at least one of the side surfaces of the circuit board.

18. The method of claim 17 wherein:
there are a plurality of spacers; and
the step of disposing the spacer upon the member further comprises disposing at least one spacer upon the upper side surface and at least one spacer upon the lower side surface.

19. The method of claim 12 wherein:
the member comprises a circuit board having upper and lower side surfaces and at least one edge portion formed between the upper and lower side surfaces; and
the spacer is disposed upon the edge portion.
